(19) United States
(12) Patent Application Publication
(10) Pub. No.: US 2016/0109243 A1
(43) Pub. Date: Apr. 21, 2016

(54) SUGGESTIVE MAPPING USING RELEVANCE BASED DRIVE INFORMATION

(71) Applicant: FORD GLOBAL TECHNOLOGIES, LLC, Dearborn, MI (US)

(72) Inventors: Fling TSENG, Ann Arbor, MI (US); Dimitar Petrov FILEV, Novi, MI (US); Imad Hassan MAKKI, Dearborn Heights, MI (US); John Ottavio MICHELINI, Sterling Heights, MI (US)

(21) Appl. No.: 14/514,753

(22) Filed: Oct. 15, 2014

(51) Int. Cl. G01C 21/26

(52) U.S. Cl. CPC G01C 21/26

(57) ABSTRACT

A vehicle includes a controller that, in response to a match between a current location of the vehicle and a recognized location, retrieves potential destinations corresponding to the recognized location. Each of the potential destinations has a ranking based on a probability that the vehicle will travel to the potential destination. The controller also outputs one or more routes between the current location and at least one of the potential destinations according to the ranking.

### TECHNICAL FIELD

The present disclosure relates to destination-prediction systems, navigation apparatus such as car navigation systems or mobile phones to which the destination-prediction systems are applied, and destination-prediction methods.

### BACKGROUND

Certain vehicles may provide infotainment information, navigation information, etc. to enhance the driving experience. The navigation information is provided by a navigation system employed to assist a driver to determine travel routes and obtain other useful travel information. The navigation system may implement functions to calculate a travel route toward a desired end destination identified by the driver starting from a given location as determined using a global positioning system. The navigation system may further implement functions for predicting the location of a driver's destination while en route, and use the predicted destination to decide what information to automatically present to the driver depending on the predicted destination.

Destination prediction techniques may involve capturing travel data in real-time during a journey, and using the captured data to determine a current position of the vehicle and predict where the vehicle is heading. As the vehicle continues on the journey, the prediction process may repeat continually, predicting new destinations as unexpected decisions are made by the vehicle/driver.

### SUMMARY

A vehicle includes at least one controller programmed to, in response to a match between a current location of the vehicle and a recognized location, retrieve potential destinations corresponding to the recognized location. Each of the potential destinations has a ranking based on a probability that the vehicle will travel to the potential destination. The at least one controller is further programmed to output one or more routes between the current location and at least one of the potential destinations according to the ranking.

A navigation prediction system includes at least one controller in communication with a database. The at least one controller is programmed to collect navigation data including start locations and end locations defining a plurality of trips. The at least one controller is further programmed to, in response to a current location for a vehicle matching one of the start locations, output predicted route information from the current location to one or more of the end locations learned to be associated with the one of the start locations based on trip vector frequencies associated with the route information exceeding a threshold.

A route mapping method for a vehicle includes receiving signals indicative of a current location of the vehicle, and in response to a match between the current location and a recognized location, retrieving potential destinations learned to be associated with the recognized location each having a ranking based on a probability that the vehicle will travel to the potential destination. The method further includes outputting signals for display indicative of one or more routes between the current location and at least one the potential destinations.

### BRIEF DESCRIPTION OF THE DRAWINGS

FIG. 1 illustrates an example block topology for a vehicle-based computing system;

FIG. 2A illustrates a flowchart of an exemplary prediction learning method that may be implemented by the vehicle-based computing system;

FIG. 2B illustrates a chart of an exemplary location record generated by the prediction learning method;

FIG. 3 illustrates a flowchart of a relative frequency routine implemented by the prediction learning method;

FIG. 4 illustrates a trip vector output generated by the prediction learning method;

FIG. 5 illustrates a flowchart of a route prediction method implemented by the prediction learning method;

FIG. 6 illustrates a route prediction by the prediction learning method; and

FIG. 7 illustrates the storing of transition information as a non-square matrix used by the prediction method to predict a destination.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

The disclosure relates to systems and methods for route prediction using machine learning algorithms including, for example, k-nearest neighbor (KNN) clustering. The systems and methods provide the prediction of one or more location and route models that are generated from self-organized drive data for identifying and filtering applicable data. In response to the filtering of the drive data, the system and method may improve the processing of data by eliminating less relevant information. The elimination of the less relevant information may allow the system to maintain a preferable database memory storage size such that newly acquired information that may have the potential of becoming an emerging pattern may be stored. The location and route models may include a rightmost previous occurrence interval table, route alternatives table, route usage frequencies table, route similarities table, average route similarities table, and route probabilities table. The location and route models may forecast one or more routes in relation to context sensitive predictions (identified driver, day of week, current location, and route ranking (highest usage route based on relative frequency).

In this disclosure, the systems may apply several methods to predict one or more locations a driver of a vehicle may be traveling to as their final destination. The methods may include location learning, relative frequency analysis of prior traveled locations, and managing a database to streamline and reduce the less relevant location learned data stored in memory. For example, previous systems and methods may log all GPS location information for later analysis. The proposed methods may compress the location information to improve analysis such that meaningful information is stored. The methods may further provide a hierarchical structure for the location information stored such that relevancy is continuously updated and maintained.

The location learning methods may provide a way to manage and update a driver's traveling behaviors and predict one or more locations the driver may be going next based on the learned data. The relative frequency analysis methods may rank the learned location data based on several factors including, but not limited to, number of times traveled, time of day, day of week, and/or a combination thereof. The database management methods may continuously update the learned data stored in memory while eliminating less relevant data based on the relative frequency analysis.

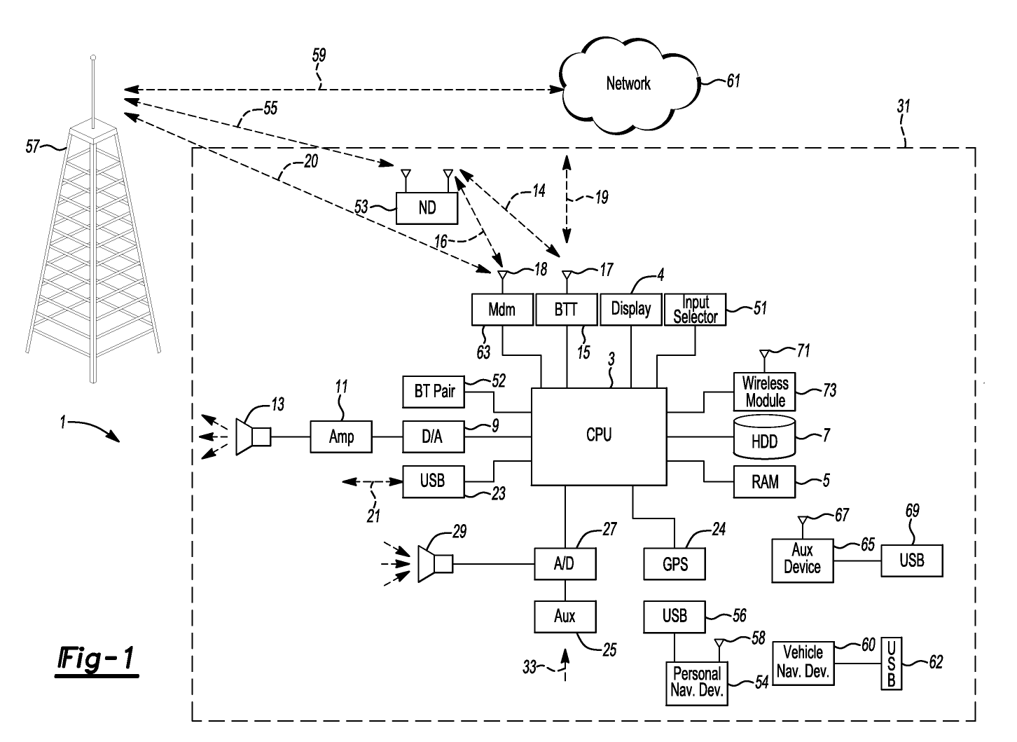

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through button presses and a spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 Khz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), and Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed in vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

The location learning method may receive location learning data from at least one of a nomadic device 53, a personal navigation device 54, a vehicle navigation device 60, an onboard GPS device 24, and/or a combination thereof. The location learning method may store data at the VCS 1. In another embodiment, the stored data may be stored at a network 61 that may be in communication with the VCS via the nomadic device 53, the onboard modem 63, an embedded phone (not shown), and/or a combination thereof.

The location learning method may provide information to one or more devices in communication with the VCS 1. For example, the location learning methods may provide route prediction to the in-vehicle display 4. In another example, the location learning methods may provide route prediction to the nomadic device 53 in communication with the VCS 1.

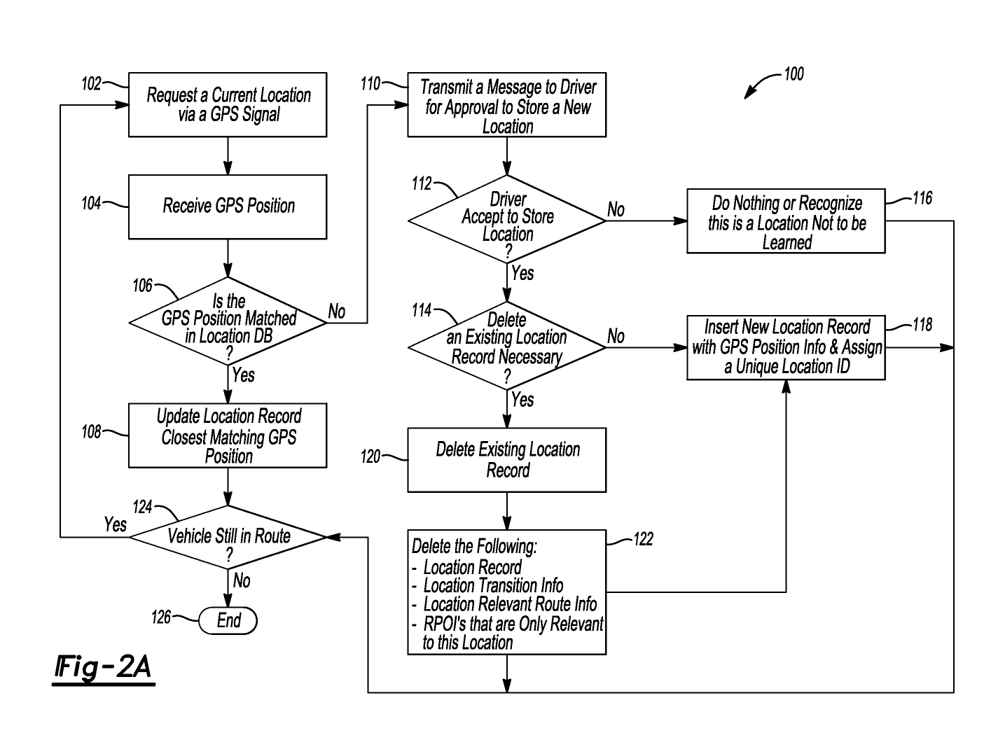

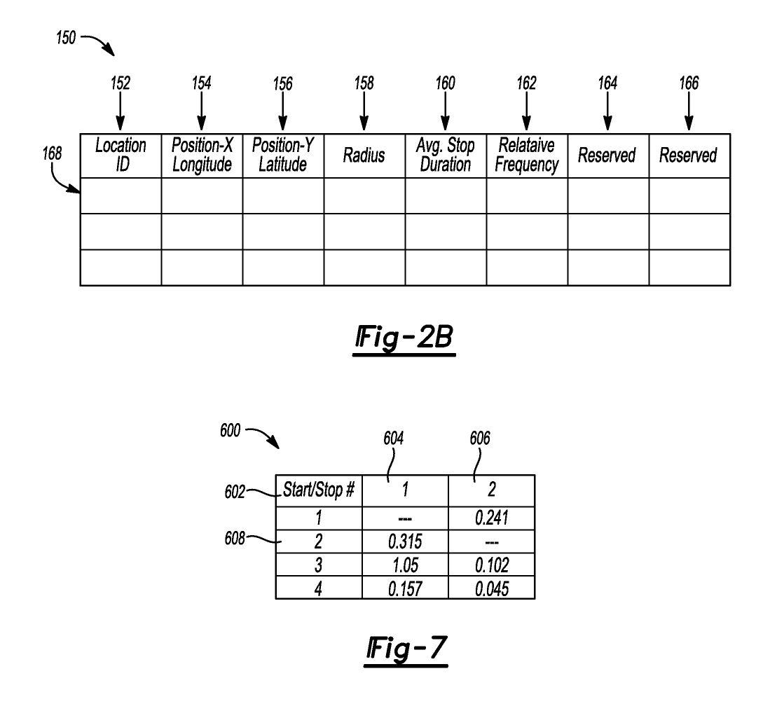

FIG. 2A illustrates a flowchart of an exemplary prediction location learning method 100 that may be implemented by the vehicle-based computing system. The prediction location learning method may comprise of one or more software applications that are executed on hardware at the vehicle computing system. The one or more applications may include instructions to populate and manage prediction location data for a route predication system. The method 100 may be implemented using software code contained within the VCS. In other embodiments, the method 100 may be implemented in other vehicle controllers, at a remote server in communication with the VCS, distributed amongst multiple vehicle controllers, or a combination thereof.

Referring again to FIG. 2A, the vehicle and its components illustrated in FIG. 1, are referenced throughout the discussion of the method 100 to facilitate understanding of various aspects of the present disclosure. The method 100 of predicting a location in response to GPS input may be implemented through a computer algorithm, machine executable code, or software instructions programmed into a suitable programmable logic device(s) of the vehicle, such as the vehicle control module, a control module at the remote server, another controller in communication with the vehicle computing system, or a combination thereof. Although the various operations shown in the flowchart diagram 100 appear to occur in a chronological sequence, at least some of the operations may occur in a different order, and some operations may be performed concurrently or not at all.

In operation 102, the method may request a current location from a global position system (GPS) in communication with the VCS. The GPS system may include, but is not limited to, the nomadic device, the vehicle navigation system, the personal navigation system, the GPS device, and/or a combination thereof. The GPS system may receive the request and transmit a signal comprising data that represents the current location of the vehicle.

In operation 104, the method may receive the GPS position data. In response to the received GPS position data, the method may compare the current location to other locations in a database to find a match in operation 106. The method provides a compressed set of data, therefore the comparison of the current location to other locations stored by the method may be done on an onboard database. For example, the method may compare the current location to the other locations in the database located at the VCS 1 (e.g., HDD 7, non-volatile random-access memory, etc.). In another example, the method may transmit the current location to a remote database stored at the network 61 in communication with the VCS 1, or at the nomadic device 53 in communication with the VCS 1, or a combination thereof.

In one example, based on the GPS position data, the system may compare the current location to stored locations in the database to determine if a user has been at this location during previous trips. The system may manage the information being stored at the database to recognize and eliminate less relevant data to ensure a concentrated system. The system is configured to maintain the database such that relevant and/or high relevant information may be retrieved quickly.

In operation 108, if the current location is matched in the database as a previous destination traveled by the driver, the VCS may update the location record matching the GPS position data. For example, the VCS may receive GPS position data recognized as the driver's place of employment, the method may update the location record of the driver's place of employment storing factors including time, date, and stop duration. The method may store additional factors including, but not limited to, the driver's place of employment transition information, the driver's place of employment relevant route information, and a route point-of-interest (RPOI) that is relevant for the driver's place of employment.

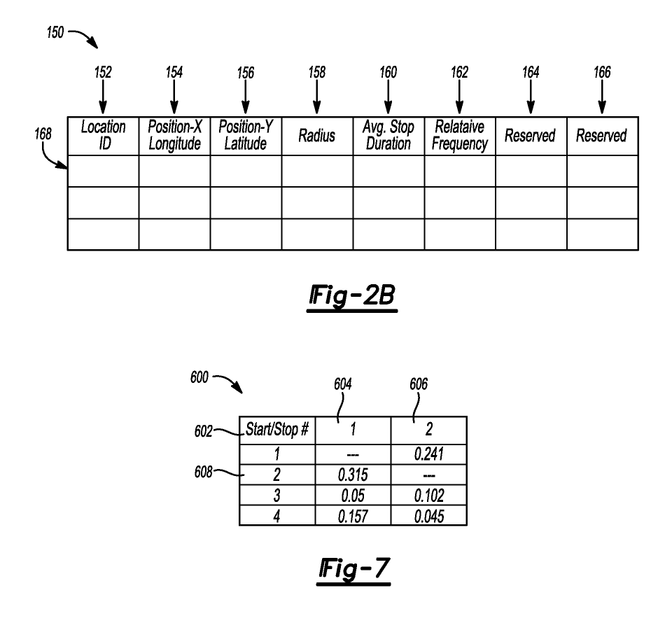

The transition information is an originally square matrix where each column and row represents a probability, or its precursor of a relative frequency value, of a transition the vehicle drives from one location to another. As shown in FIG. 7, the transition information is illustrated as a non-square matrix 600 because such a matrix may be trimmed if the method does not store zero values. In addition, it is rare that a trip's starting location and destination location 602 are the same location therefore the diagonals are generally zero or a very small number. FIG. 7 illustrates a starting location row 602 that may be used to determine a start location at a key-on event. In this example, the starting location row 602 comprises a location one column 604 and a location two column 606. The method may determine that the vehicle is at location number one at the key-on event. Once it is determined that the vehicle is at location one, the method may proceed to use the information from the location one column 604 to rank the possible destinations. In the location one column 604, the second location 608 has the highest relative frequency value and therefore may be predicted as the most likely destination. This process may continue if an additional destination candidate is needed to be predicted for the driver. In this example, the probability of the driver to go from location one to location two may therefore be set to 0.315/(0.315+0.05+0.157). Ranking with relative frequency and probability are the same because the latter is simply a normalized version of it.

Relevant route information includes a sequence of recognized RPOIs. An RPOI is a GPS position that the method has recognized as a point in the geographical space where the vehicle has driven by during one of the trips. In other words, the RPOI is a collection of GPS positions that are a subset of previous destinations, when sequenced properly, that forms a complete trip trace of the driver. Since most people frequent a set of locations like home, work, and school, there is a lot of common points-of-interest that he/she drives by even during different trips. One example of such an RPOI is the road segments that lead to a person's home. The method may reuse these road segments (a segment is defined by 2 different RPOIs), organized differently to represents all routes that may be driven. A trip generally includes a starting location and a destination in which a unique trip identification number will be assigned (e.g., trip from location A to location B and a trip from location B to location A may have different trip ID numbers). A full route associated with a trip may therefore be a sequence of RPOIs that are associated by attaching the trip ID to it. For each trip, there may be more than one route associated with it. From observation of these trips, a relative frequency is attached with these routes and are updated similarly to the way location transition are learned such that over time, relative importance of each route will be learned and used for predictive purposes. For example, a driver is at location A and the system predicts that the driver may be going to location B, location C or location D each with different probability. The driver may suggest, using one or more user inputs at the VCS, that he is indeed going to location B. In response to the driver's suggestions, the method may then go ahead to predict his mostly likely route(s) going from location A to location B, and overlay live traffic and/or incident information. The method may provide live traffic and/or incident information such that the driver may preview relevant information before picking a route.

In operation 110, if the current location is not matched in the location learned database, the method may transmit a message to the driver asking for approval to store a new location based on the GPS position data. For example, the method may output a message at a display requesting driver input on whether or not the database should be updated with this new location not found in the database.

In operation 112, in response to the message to store the new location data at the database, the driver may accept, decline, or ignore the message. If the driver ignores the message and/or declines the message to update the database with the new location, the method may recognize this is a location not to be learned and stored at the database. In response to the driver accepting to save the new location in the database, the method may have to delete an existing location record to make storage space for the new location in operation 114. In another embodiment, the method may automatically delete an existing location record based one or more factors including limited space, last time the driver has been to the location, number of times the driver has been to the location, and/or a combination thereof. The method may recognize existing locations that are of low relevance based on the one or more factors, such that if space is needed in the database the method may automatically delete these less relevant records.

In operation 118, if the deletion of an existing location record is not necessary, the method may insert a new location record with the current location GPS position information and assign a unique location identifier to store the data entry in the database. If the method requires that a new location record is necessary, then an existing location record with low relevancy is deleted in operation 120.

In operation 122, the method may delete the existing location record, the associated location transition information, location relevant route information, and a route point-of-interest (RPOI) that has low relevance for the current location. Once the method has completed the deletion of an existing location record, the method may insert a new location record with GPS position data information and assign a unique location identifier in operation 118.

In operation 124, the method may continue to request GPS data if the vehicle is still en route to a destination. For example, the method may continuously request GPS data for receiving route information while collecting and tracking RPOIs from a start location to an end location. The route information may be stored and correlated with the start location record and/or the end location record in the database.

In operation 126, if the method detects a key-off event, the method may end the one or more software applications used to manage and execute the learned location of the driver's destination habits. The vehicle computing system may have a vehicle key-off mode to allow the method to request GPS location data and store the data to associate it with the end of destination location in the database in response to a key-off event. For example, if a driver key's off the vehicle, the method may store that route information as the end of destination when the VCS detects a key off event, the method may also store in memory the GPS location data such that the information may be used by the system for the next key-on event to determine a start location.

FIG. 2B illustrates a chart 150 of an exemplary location record generated by the prediction learning method 100 and stored at the database. The chart 150 may populate location information for one or more location records based on the received GPS data during the operation of the vehicle.

For example, the method may receive start location data and either compare the location record in the database looking for a match in response to the start location via the GPS coordinates or populate the chart with a new location entry. The chart 150 may generate a specific entry line 168 for the start location data based on the new location information. The chart 150 may include a unique location identification 152 for the start location. The chart 150 may also include longitude position data 154 and latitude position data 156 for the start location. The chart 150 may include radius information for the start location. The chart 150 may also include an average stop duration 160 and a calculated relative frequency 162 for the start location. The relative frequency 162 will be explained in more detail below. The chart 150 may also include one or more reserved cells 164, 166 for additional information including, but not limited to, the last visit date of the start location.

The route prediction system and method may calculate a relative frequency to predict a destination location for a driver of the vehicle based on one or more factors. The one or more factors may include GPS information, start location, time of day, and/or a day of the week. The relative frequency is a precursor to probability such that the route prediction method may count against known alternatives (e.g., a location, route, address, business, work, home, etc.).

The relative frequency may be the numeric value to rank a predicted location based on the one or more factors. The method may use the relative frequency as a precursor to probability by enabling the trips to be counted against known alternatives (e.g., location/route). For example, a numeric example for a trip starting at location A may have alternative routes to one or more end destinations. For this example, the end destinations may include location B, location C and location D. The method may use relative frequency as a gauge of relative importance of a piece of information to predict if the driver is traveling to a particular destination and/or if the method should delete data that is of low relevance and therefore not needed. The method uses relative frequency as a weight in which there is a need to aggregate the location information data.

Continuing from the example above, the method may search the data and find three alternative end destination options C, B, and D based on the one or more factors for start location A. For example, if the start location A is a driver's home, the method may look to the database to deliver the predictive options for a route to the predicted driver's end destination including end destination B (work), end destination C (gym), and end destination D (coffee shop). The relative frequency is used by the method as a gauge of relative importance in response to destination information received from the GPS data. The method may use the relative frequency as a weight to calculate which route to output when there is need to aggregate information such as destination B, C, and D in the location database. The relative frequency may be established as a first order exponential smoothing calculation based on the following equation:

X(t)=(1−α)*X(t−1)+α*x(t); (1)

wherein the first order exponential smooth value X comprises a moving window learning rate a, an actual time value t, and a trip vector x(t).

From the example above, say the learning rate is α=0.05, or a moving window of 1/0.05=20, of similar observations (e.g., trip starting from location A (home) and the predicted route options may include end destinations B, C, or D). Based on the set learning rate above, we are updating information whenever a trip vector is formed, therefore the method may capture information form the last twenty (20) observations. For example, starting at location A, the method may retrieve information from the last twenty trips that have started from location A.

The relative frequency may be updated after a new trip vector has been formed. The trip vector is explained in more detail below. The vector contains an encoded starting location destination as a unique number. From the starting location number (location A), the method identifies all the alternatives relevant to the same starting location.

For example, the trip vector indicates a trip having a start point of location A and an end location of location B. The method may update the database such that the data stored reflects that the trip has started at location A and has finished at location B. If the driver starts at A and ends at B, the method may increment the trip data for location A to location B therefore increasing the relative frequency for that trip vector. In response to the end destination at location B, the method may than decrease the relative frequency values for the alternative destinations having a start location A but not ending at location B.

The method may receive a signal from the GPS such that the data is continuously evaluated to extract and/or compress into a route point-of-interest. The method may receive the starting location and ending location to update the database. The trip vector x is based on the start location and end location, and may be either a True or False value between competing alternative destinations. The destination prediction method may compare the same start location to the one or more end destinations stored in the database such that the end destinations are viewed as competing route alternatives.

The method may use the common formulation of a low pass filter as shown in the following equation:

RF_{A to B/C/D}=(1−α)*X_{A to B/C/D}+α*(Flag_{True or False}) (2)

wherein Flag_{True or False} is indicative of a trip vector used by the method to determine if a start location and end location has occurred. For example, if the trip is from location A to location B, then the Flag for location A to location B may be set to true. Using the same example, if the trip vector is from location A to location B, then the Flag for the rest of the trips not ending in location B (location A to location C and location A to location D) may be set to false.

If the trip vector is a new trip not stored in the database, the method may store the new trip in the database and set the Flag to true. For example, if the trip vector is location A to location E and this trip vector is new, the method may set the Flag to true and the rest of the trips not ending in location E (location A to location B, location A to location C, and location A to location D) may be set to false. In response to the new trip vector, the method may increase the database size for location A by one new space reserved for the new trip vector location A to location E.

The relative frequency from the start location to the one or more end destinations may be used to enable the system to predict the route of a driver. The method may assign relative frequency values in one or more location records stored at the database.

For example, the method may generate a location record for the trip vectors based on four trips taken by a driver starting at location A as follows:

TABLE 1

| | Start | | | | |
|---|---|---|---|---|---|
| Trip | Location | End Location | RF_{A to B} | RF_{A to C} | RF_{A to D} |
| Initial Values | 0 | 0 | 0 | 0 | 0 |
| 1 | A | B | 0.05 | 0 | 0 |
| 2 | A | C | 0.048 | 0.05 | 0 |
| 3 | A | D | 0.045 | 0.048 | 0.05 |
| 4 | A | C | 0.043 | 0.095 | 0.048 |

The location record may have the following initial values (RF₀) for the relative frequency equal to zero for all the predicted end destinations. Note that RF_{A to B}, RF_{A to C}, and RF_{A to D} are initialized to have a value of zero (0). Based on Table 1, the relative frequency for the initial value at RF₀ may comprise values set to zero and after the first trip, the relative frequency is calculated using the following equations:

RF_{1, A to B}=0.05=(1−0.05)*X_{0, A to B}+0.05*(Flag_{True or False}) (3)

RF_{1, A to C}=0.00=(1−0.05)*X_{0, A to C}+0.05*(Flag_{True or False}) (4)

RF_{1, A to D}=0.00=(1−0.05)*X_{0, A to D}+0.05*(Flag_{True or False}) (5)

Since the trip vector from trip 1 indicates a trip started from location A and ended at location B, Flag_{True or False} is set to true in equation 3. Therefore, the Flag_{True or False} in equation 3 comprises a value equal to one and in equation 4 and equation 5 the Flag_{True or False} is false comprising a value equal to zero. The overall effect of having a trip vector starting at location A and ending at location B causes the method to update the trip vector RF_{A to B} by an increment in value since it matched the most current recent trip information contained in the trip vector. The trip vectors RF_{A to C}, and RF_{A to D} do not match the most recent trip vector. Therefore the method recognizes that the relative frequency experienced no value change since they already comprise an initial value at zero. Table 2 below represents the relative frequency normalized into probability information. After trip 1, the probability of location A to location B is set to a value of one since at that time, trip vector A to B is the only trip the method has observed. The probability information may match the method's expectation of predicting a route for a driver as if the method is counting the occurrences of the trips.

After the second trip, the relative frequency is calculated using the following equations:

RF_{2, A to B}=0.048=(1−0.05)*RF_{1, A to B}+0.05*(Flag_{False}) (6)

RF_{2, A to C}=0.050=(1−0.05)*X_{2, A to C}+0.05*(Flag_{True}) (7)

RF_{2, A to D}=0.00=(1−0.05)*X_{2, A to} D+0.05*(Flag_{False}) (8)

Since the trip vector for trip 2 is from location A to location C, the method may update all trips relevant to location A as a starting location. In response to trip 2, the method may update the trip vector for location A to location C. The RF_{2, A to C} Flag is set to True, and therefore has a value of one in equation 7 while the other trip vector equations for start location A have a value set to zero. After trip 2, the method may update the probability value as show in Table 2 such that the probability values match roughly what we have experienced which was one trip to B and one trip to C based on a start from location A.

After the third trip, the relative frequency is calculated using the following equations:

RF_{3, A to B}=0.045=(1−0.05)*0.048+0.05*(Flag_{False}) (6)

RF_{3, A to C}=0.048=(1−0.05)*0.05+0.05*(Flag_{False}) (7)

RF_{3, A to D}=0.050=(1−0.05)*X_{A to D}+0.05*(Flag_{True}) (8)

Since the trip vector for trip 3 is from location A to location D, the method may update all trips relevant to location A as a starting location. In response to trip 3, the method may set the Flag to True for location A to location D, therefore having a value set to one in equation 8 while the other trip vector equations have a value set to zero. After trip 3, the method may update the probability value as shown in Table 2, such that the probability values match roughly what we have experienced, which was one trip to B, one trip to C and one trip to D based on a start from location A.

After the fourth trip the relative frequency is calculated using the following equations:

RF_{4, A to B}=0.043=(1−0.05)*0.045+0.05*(Flag_{False}) (9)

RF_{4, A to C}=0.095=(1−0.05)*0.05+0.05*(Flag_{True}) (10)

RF_{4, A to D}=0.048=(1−0.05)*0.05+0.05*(Flag_{False}) (11)

Since the trip vector for trip 4 is from location A to location C, the method may update all trips relevant to location A as a starting location. In response to trip 4, the method may only have the Flag set to True for location A to location D, and therefore have a value of one used in equation 10 while the other trip vectors starting at location A are False and set to a value of zero in the remaining equations. After trip 4, the method may update the probability value as shown in Table 2, such that the probability values match roughly what we have experienced, which was one trip to B, two trips to C and one trip to D based on a start from location A.

The prediction method may be an implementation of counting and ranking the data content in a moving window using relative frequency. The method may calculate the relative frequency normalized such that the location prediction data becomes a probability value. Continuing from the example above, the method may generate a probability for the location record based on the four trips taken by a driver starting at location A as followed:

TABLE 2

| | Relative Frequency | | | Probability Vector | | |
|---|---|---|---|---|---|---|
| Trip | RF_{A to B} | RF_{A to C} | RF_{A to D} | A to B | A to C | A to D |
| Initial | 0 | 0 | 0 | 0 | 0 | 0 |
| 1 | 0.05 | 0 | 0 | 1 | 0 | 0 |
| 2 | 0.048 | 0.05 | 0 | 0.49 | 0.51 | 0 |
| 3 | 0.045 | 0.048 | 0.05 | 0.31 | 0.34 | 0.35 |
| 4 | 0.043 | 0.095 | 0.048 | 0.23 | 0.51 | 0.26 |

As shown in Table 2, for the same start location the method may predict likely destinations with a probability value. For each trip the method may predict likely full routes in response to the probability values. The probability values for each trip is calculated based on the following equations:

$$\begin{matrix}A to B = \frac{{RF}_{A to B}}{{RF}_{A to B} + {RF}_{A to C} + {RF}_{A to D}} & ( 12 ) \\ A to C = \frac{{RF}_{A to C}}{{RF}_{A to B} + {RF}_{A to C} + {RF}_{A to D}} & ( 13 ) \\ A to D = \frac{{RF}_{A to D}}{{RF}_{A to B} + {RF}_{A to C} + {RF}_{A to D}} & ( 14 )\end{matrix}$$

The method may determine when certain inputs are missing and use relative frequency as a weight/factor to draw inference against unknowns. For example, if the GPS reception is bad and a starting location is unknown, the method may use an overall average of all starting locations to predict an end destination. The system may require a data size requirement, therefore enabling the method to combine relative frequency with factors that include an age for the information and other supporting information to delete less important and/or less frequently used location data content stored at the database.

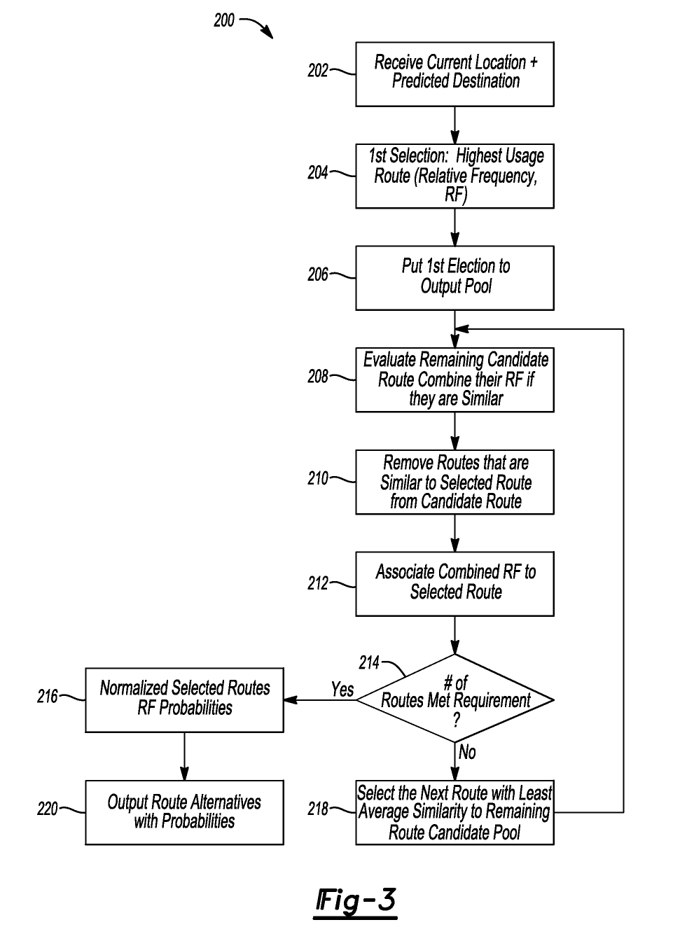

FIG. 3 illustrates a flowchart of a relative frequency routine implemented by the prediction learning method. The method 200 of predicting a route to one or more locations in response to GPS input may be implemented through a computer algorithm, machine executable code, or software instructions programmed into a suitable programmable logic device(s) of the vehicle, such as the vehicle control module, a control module at the remote server, another controller in communication with the vehicle computing system, or a combination thereof. Although the various operations shown in the flowchart diagram 200 appear to occur in a chronological sequence, at least some of the operations may occur in a different order, and some operations may be performed concurrently or not at all.

In operation 202, the method may receive a current location via the GPS and a predicted destination based on the relative frequency and/or probability vectors. The method may make a first selection based on the highest usage route calculated by the relative frequency in operation 204. In operation 206, the method may output the first selection in a pool of other predicted location(s) that may have a higher relative frequency and/or probability vector in response to one or more factors. The one or more factors may include the previous received GPS data, start location, day of the week, time of day, and/or other variables that may be used to predict the drivers intended end destination. For example, based on the availability of input using the one or more factors (time of day, day of the week, current location, etc.), the method may produce a list of candidate destinations that most matches the given inputs. In one example, if no location, nor day, nor time information is available, the method may produce a prediction based on overall average (unconditional probability) of all the predicted locations stored at the database.

In another example in which the current location, day, and time information are all available, the method may predict, based on conditional probability, where the location destination prediction may be made based on past information that match those inputs.

In operation 208, the method may evaluate remaining candidate routes and combine their relative frequency if the routes have a similar end destination. The method may remove routes that are similar to a selected route from the candidate pool of routes in operation 210. For example, the method maintains a database pool of candidate routes for the trip vector comprising a start location at location A to an end destination of location B. When a request is made by the method to make a prediction, the method may go through an analysis procedure to identify the most important (high relevance) yet different route from this database pool, therefore combining the relative frequency values for the similar routes to improve the prediction.

In operation 212, the method may combine associated relative frequency to selected routes that are similar such that the prediction is based on a higher probability of the driver traveling that route. The method may require that a predefined number of routes are generated to ensure a robust prediction of driver's intended destination in operation 214.

In operation 218, if the method does not generate enough routes to meet the predefined number of routes required to make a prediction, the method may select the next route with the least average similarity from the remaining route candidate pool. The method may continue to analyze the next route with the least average similarity in operations 208 through 212 to ensure a robust prediction of the driver's intended driving route.

In operation 216, once enough routes are generated based on the predefined number of routes required, the method may normalize the selected routes using relative frequency. The method may output the route alternatives with the associated probabilities in operation 220. The route alternatives may be displayed to a user via one or more user interface devices. The user interface devices may include a center stack LCD screen, instrument panel, a driver's mobile device in communication with the VCS via a Bluetooth connection, or a combination thereof.

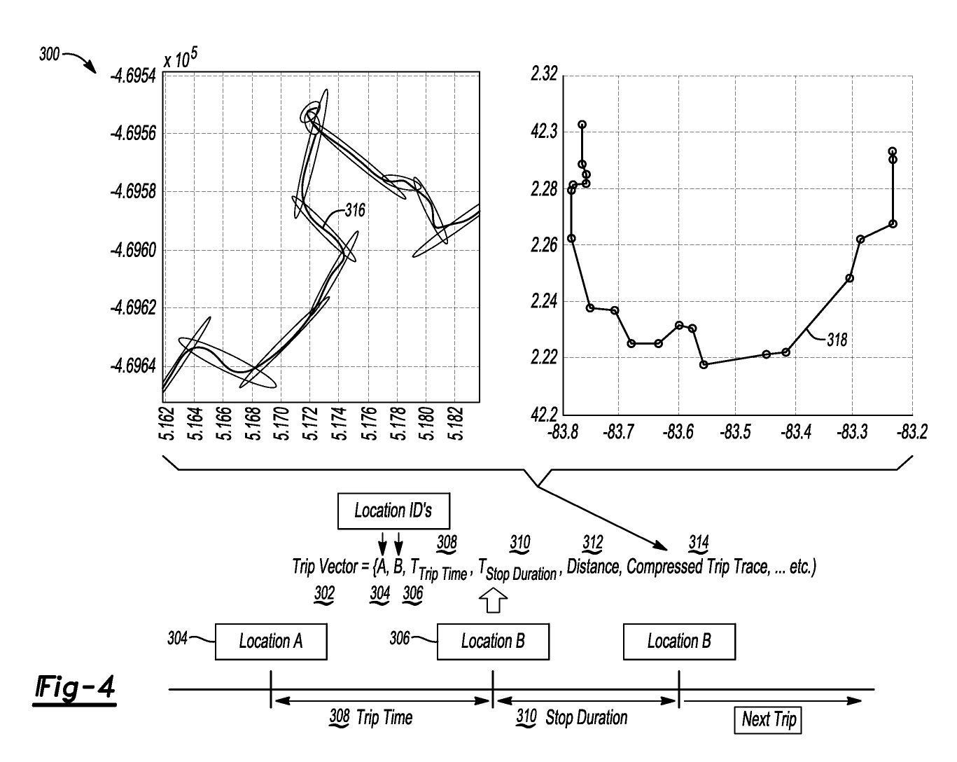

FIG. 4 illustrates a trip vector output 300 generated by the prediction learning method. The method may form a trip vector 302 in response to several data points that include information collected via the GPS, the GPS information correlated with additional factors such as time of day and day of the week, and the calculations made by the method to rank the GPS information using relative frequency.

The trip vector 302 may receive the location data based on two locations. For example, the trip vector 302 may receive location A 304 data points and location B 306 data points. The trip vector 302 may receive trip time 308 to travel from location A 304 to location B 306. The trip vector 302 may take into account stop duration 310 taken by the driver at location B 306.

The information gathered for the trip vector may be used to improve the prediction of a route for the driver. For example, the stop duration and last visit date of a location may be useful to evaluate the overall significance of the trip. The compressed trip trace may be used by the method as an analysis and compare with existing route alternatives to recognize a driver's preference in terms of a route. The compressed trip trace may be used by the method as a pre-probe route traffic and/or incident analysis for the driver.

The trip vector 302 may take into consideration compressed trip traces 314 such as a route point of interest 318 to location B, location C, location D, etc. The method may generate a route point of interest 318 by including a radius 316 of other points of interest that may be of importance to the driver. For example, for a highly frequent route like home to work or work to home, the driver may follow 95% of the route when compared to a computer generated predicted route. The driver may deviate but for a portion of the route (e.g., when he gets very close to home/work) if he has some personal preferences and this portion may always be different than what the computer is suggesting. By this analysis of information of this type of deviation a driver may take in a route, the method may be able to predict alternative routes how a driver goes from location A (home) to location B (work).

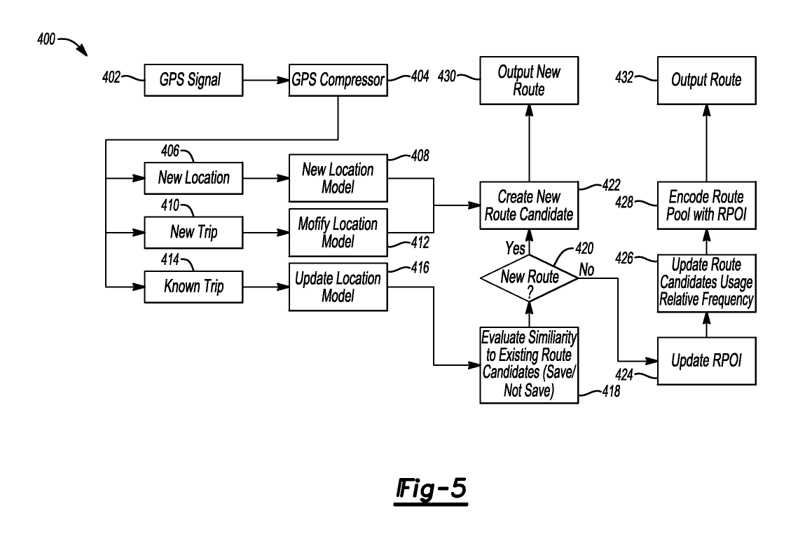

FIG. 5 illustrates a flowchart of a route prediction method 400 implemented by the prediction learning method. The route prediction method 400 may be implemented through a computer algorithm, machine executable code, or software instructions programmed into a suitable programmable logic device(s) of the vehicle, such as the vehicle control module, a control module at the remote server, another controller in communication with the vehicle computing system, or a combination thereof. Although the various operations shown in the flowchart diagram 400 appear to occur in a chronological sequence, at least some of the operations may occur in a different order, and some operations may be performed concurrently or not at all.

In operation 402, the method may receive a GPS signal comprising current location data. The GPS signal may be received by a GPS compressor such that the data may be filtered to determine if the current location is a new location, a new trip and/or a known trip in operation 404. For example, the GPS compressor is applied by the method when the vehicle is being driven and the GPS data stream is continuously being compressed to identify RPOIs. The method may recognize a sequence of RPOIs that represents full routes in a compact form without logging and/or saving a full GPS stream.

In operation 406, in response to the GPS data, the method may recognize a location (e.g., recognize a location using KNN) and if a new location is recognized, prepare the database to store the new location information. In one example, the method may identify a new location based on the vehicle's position not being recognized in any of the existing locations stored in the database during a key-on or key-off event. Once a new location is identified, the method may use the current trip vector to initialize some location attribute such as overall relative frequency and/or stop duration. The method may collect additional parameters to populate the new location information including date and time.

In operation 408, the method may generate a new location model based on the new location data. The new location model is generated by the method by accumulating knowledge relevant to the new location. For example, storing the locations that are related to the new location as a destination and/or as a route.

In operation 410, in response to the GPS data, the method may prepare the database to store the new trip information. For example, the method may collect additional parameters associated with the new trip.

In operation 412, the method may modify the location model based on the new trip. For example, the method may modify the location model by adding and/or modifying a new entry in the location list, location transition information, and route information.

In operation 414, in response to the GPS data, the method may prepare the data to store known trip information. For example, the known trip information may include a known start location, end location, trip vector, and/or a combination thereof. The method may prepare the database to update the location model in operation 416. For example, the method may update the location model by updating and/or modifying the location list, location transition information, and route information of an existing trip (e.g., location A to location B).

In operation 422, in response to the GPS data comprising a new location and/or a new trip, the method may create a new route candidate. The new route candidate provides a new entry into the database to store information related to the new location and/or new trip. For example, a route is associated with a trip where a starting location and an ending location are fixed and the route includes a sequence of RPOIs. A new route candidate is generated when a compressed GPS stream is considered to be different to existing route candidates by at least a certain threshold recognized by the prediction method. The certain threshold information may include, but is not limited to, start location, end location, date, time, radius data, and/or a combination thereof. For example, a center and a radius may define a location or a RPOI because each GPS unit has a precision limit (e.g., a range of the precision limit may be set from 5 to 100 meters and anywhere in between) in which within that range, it considers the locations as being the same. The method may use the center and radius precision limit since it is storage friendly and provides for ease of computation.

In operation 430, the method may output the new route. For example, when a new candidate route is stored, the method may begin to monitor the new candidate route's usage and compare to route alternatives.

In operation 418, in response to the GPS data comprising a known trip, the method may evaluate similarity to existing route candidates and either save additional data and/or delete irrelevant data. For example, if the known trip is a trip vector that includes start location A to end location B, and the additional data includes weekdays (Monday thru Friday) with a start time of 8:00 A.M. and an end time of 8:25 A.M., the method may look to add the additional data to the database, while eliminating outlier data. Using the same example, the additional data may show that the trip vector of location A to location B always starts between 7:45 AM to 8:15 AM on a weekday. If, however, there is one data point showing a start time of 11:15 AM, this data point may be eliminated since it is an outlier.

In operation 420, the method may verify that the known trip has one or more derivatives based on the additional data such that a new route entry may be required. For example, the driver may previously drive the same highway to work and if it snows, the driver would switch to a mostly local route as he knows it might save him time during his trip. The method may observe and analyze if these two routes (the regular highway route and the snow local route) are sufficiently different by evaluating the RPOI vector. The method may store both routes in the system as full alternative routes.

In operation 424, the method may update the RPOI based on the known trip information and the updated location model. The method defines the RPOI by a center and a radius. For example, the method may apply a sequence of RPOIs to effectively reconstruct a full route with a much smaller footprint in terms of storage. RPOIs may be re-used for different routes. In another example, RPOIs near the driver's home may be reapplied for other routes leading to different end destinations.

In operation 426, the method may update the route candidate(s) usage based on the relative frequency. The method may encode the database (route pool) with the RPOI information in operation 428.

In operation 432, the method may output a route based on the route pool such that the driver may have an option of one or more routes to take in response to GPS data and/or other additional information.

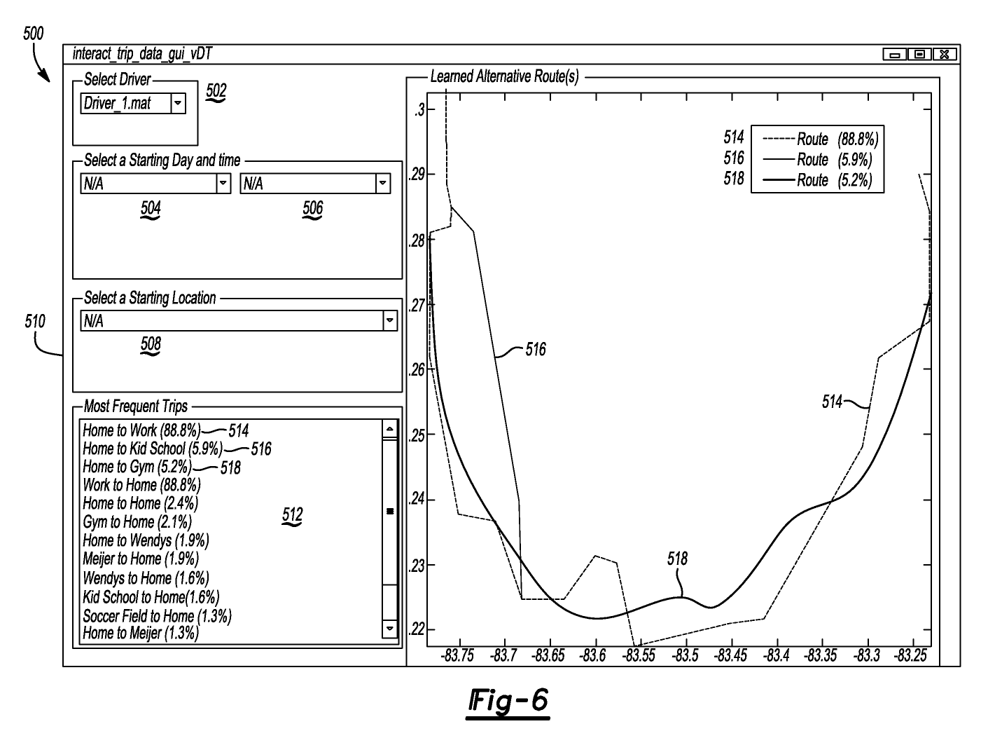

FIG. 6 illustrates a route prediction 500 generated by the prediction learning method. The prediction learning method may be executed at the VCS using one or more processors. The prediction learning method may receive GPS data comprising location information to generate one or more route predictions. The route predictions may be based on additional factors and/or information including, but not limited to, a particular driver 502, time of day 504, day of the week 506, the starting location 508, and/or a combination thereof.

The route prediction 500 may generate several most frequent trips 510 based on at least one of the driver 502, the time of day 504, the day of the week 506, and the starting location 508. For example, based on one or more factors, the route prediction 500 may generate and output three potential routes including, Route 1 514, Route 2 516, and Route 3 518. The method may determine that the start location 508 is Home and based on the time 504 and day 506, the following routes with the associated probabilities are generated: Route 1 514 Home to Work having a probability of 88.8%, Route 2 516 Home to Kid School having a probability of 5.9%, and Route 3 518 Home to Swimming Pool having a probability of 5.2%.

The method may generate an output message such that the VCS may display the one or more predicted routes (Route 1 514, Route 2 516, and/or Route 3 516). In one embodiment the method may only output the top three routes based on probability such that the driver may select the actual intended route. In another embodiment, the method may output the highest probability route.

The route prediction methods and systems enable a more robust and efficient way to predict driver intended trips while allowing one or more vehicle computing systems to provide alerts related to construction, accidents, traffic, points of interest, and/or a combination thereof. The route prediction methods and systems disclosed in this patent application may eliminate less relevant data such that the database may be stored at the VCS to provide an improved processing of the route prediction output to the driver. The location, trip, and route stored in the database enable the methods to provide a hierarchy and relevance information that are maintained such that relevance information enables scalable probabilistic information. The methods may provide a given level of detail in the context of time, day and/or location such that the relevance information enables data management including deletion of less relevant data. The methods enable the data to automatically be reflective of recent information without detailed data logging.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A vehicle comprising:
a controller programmed to,
in response to a current location of the vehicle, retrieve potential destinations corresponding to the current location each having a ranking based on a probability that the vehicle will travel to the potential destination,
output a route between the current location and at least one of the potential destinations according to the ranking, and
output a message to save a new destination not listed in the potential destinations.

2. The vehicle of claim 1, wherein the controller is further programmed to, in response to received user input accepting the message to save the new destination, record the current location and a corresponding unique location ID for the new destination.

3. The vehicle of claim 1, wherein the controller is further programmed to delete a portion of potential destinations based on the potential destination associated with the current location having a frequency value below a relevancy threshold.

4. The vehicle of claim 1, wherein the potential destinations are stored in memory on the vehicle and in communication with the controller.

5. The vehicle of claim 1, wherein the controller is further programmed to generate a trip vector from the current location to the at least one potential destination, and update the route based on the trip vector.

6. A system comprising:
a controller programmed to
collect navigation data including start locations and end locations defining a plurality of trips,
output, for selection, a portion of the plurality of trips by filtering predicted route information for a current location matching one of the start locations to one or more of the end locations learned to be associated with the current location based on trip vector frequencies associated with the route information exceeding a threshold.

7. The system of claim 6 further comprising an interface configured to receive a selected predicted route from the portion of the plurality of trips and display the predicted route information associated with the selected predicted route.

8. The system of claim 6, wherein the controller is further programmed to learn the trip vector frequencies during the trips.

9. The system of claim 6, wherein the controller is further programmed to, in response to the current location not matching one of the start locations, record the current start location and a corresponding unique location ID.

10. The system of claim 6, wherein the controller is further programmed to delete at least one of the end locations based on a matching frequency associated therewith.

11. The system of claim 6 further comprising a memory in communication with the controller and wherein the start locations and end locations are stored in the memory.

12. A method comprising:
in response to a recognized current location via a vehicle computing system, retrieving potential destinations learned to be associated with the current location, the potential destinations each having a ranking based on a probability that the vehicle will travel to the potential destination;
displaying a route between the current location and at least one the potential destinations; and
outputting a save message for a new destination not listed in the potential destinations.

13. The method of claim 12 further comprising, in response to received user input accepting the save message, recording the current location and a corresponding unique location ID for the new destination.

14. The method of claim 12 further comprising deleting a portion of the potential destinations based on the at least one potential destination associated with the current location having a frequency value below a relevancy threshold.

15. The method of claim 12, wherein the potential destinations are retrieved from a memory in the vehicle computing system.

16. The method of claim 12 further comprising generating a trip vector from the current location to the at least one of the potential destinations and updating the route based on the trip vector.
